(19) United States
(12) Patent Application Publication
(10) Pub. No.: US 2012/0193009 A1
(43) Pub. Date: Aug. 2, 2012

(54) SUBSTRATE BONDING METHOD AND SUBSTRATE BONDING APPARATUS

(75) Inventor: Nobutoshi Fujii, Kanagawa (JP)

(73) Assignee: SONY CORPORATION, Tokyo (JP)

(21) Appl. No.: 13/349,707

(22) Filed: Jan. 13, 2012

(30) Foreign Application Priority Data
Feb. 2, 2011 (JP) 2011-020394

(51) Int. Cl. B32B 37/00

(52) U.S. Cl. 156/60; 156/580

(57) ABSTRACT

A substrate bonding method includes: applying a predetermined load to a first substrate by causing a pressing member to come into surface contact with a predetermined region of the first substrate; and simultaneously with the applying of the predetermined load or after applying the predetermined load to the first substrate, in the state where the pressing member comes into surface contact with the first substrate, causing the first substrate to come into contact with a second substrate.

### BACKGROUND

The present disclosure relates to a substrate bonding method and a substrate bonding apparatus.

Typically, as a method of adhering two wafers (bonding method), for example, there have been a method using an adhesive or the like, a method of causing two wafers to come into direct contact with each other and bonding the wafers, and the like. In addition, as one example of the latter method, there is a method of activating the bonding side surfaces of wafers and bonding the surfaces to each other. The bonding method is employed when, for example, a silicon on insulator (SOI) is produced (for example, refer to Japanese Unexamined Patent Application Publication No. 2-183510).

In addition, in a case where the method of activating and bonding the wafer surfaces is applied to, for example, wafers in which semiconductor elements, wiring, and the like are formed, bonding the surfaces at a temperature so as not to break up the semiconductor elements, wiring, and the like is necessary during bonding. Therefore, typically, as the bonding method, a method capable of allowing bonding at a low temperature, called surface activated bonding by plasma has been developed (for example, refer to S. Farrens, et. al., J. Etectrochem. Soc., Vol. 142, No. 11 (1995) 3949).

In the method of surface activated bonding by plasma, generally, in a state where the activated surfaces of two wafers are overlapped with each other, bonding by van der Waals forces is performed by applying a load to (pressing) a single point of one wafer. Here, in order to suppress stress on the wafers and the generation of voids during bonding, it is preferable that the load applied to the wafer be reduced (for example, refer to Japanese Unexamined Patent Application Publication No. 2006-269850). In addition, in Japanese Unexamined Patent Application Publication No. 2006-269850, a wafer bonding method of overlapping and aligning two wafers with each other and subsequently applying a load thereto is proposed. In addition, typically, as a pressing method during bonding, a method of pressing chamfered portions of wafer edges has been proposed (for example, refer to Japanese Patent No. 3532320).

As described above, in the method of activating and bonding the wafer surfaces, typically, various bonding techniques have been proposed. However, when two wafers are bonded to each other, as well as the bonding technique, a technique of alignment between wafers before bonding is also important. In particular, in a case where a 3D device is produced, two wafers have to be bonded to each other after the positions of the patterns respectively formed in the two wafers are aligned with good precision.

Typically, as the wafer alignment method, a method of performing alignment by, using the outside diameters of wafers and cutouts for positioning (for example, orientation flats, notches, and the like), pressing the outer peripheries of the wafers against a pin provided at a predetermined position of a bonding apparatus has been proposed (for example, refer to Japanese Unexamined Patent Application Publication No. 2002-190435).

In addition, typically, as the wafer alignment method, a method of optically detecting predetermined marks or patterns formed in the pattern of each wafer and performing alignment on the basis of the detection result (hereinafter, also referred to as an optical alignment method) has been also proposed. The optical alignment method can realize more precise alignment than, for example, a method proposed in Japanese Unexamined Patent Application Publication No. 2002-190435 and the like, that is, a method in which alignment precision is dependent on the outside diameter precision of wafers.

### SUMMARY

As described above, in the case where two wafers (substrates) are bonded to each other using the optical alignment method, alignment between the two substrates can be performed at high precision. However, in a case where adsorption of the wafers onto a stage is excluded after optical alignment in order to reduce a wafer stress during wafer bonding, it becomes difficult to perform bonding while maintaining an alignment precision adjusted to a high precision.

It is desirable to provide a substrate bonding method and a substrate bonding apparatus capable of maintaining an alignment precision between two substrates before bonding, which is adjusted to a high precision, after the bonding.

According to an embodiment of the present disclosure, there is provided a substrate bonding method performed in the following order. First, a predetermined load is applied to a first substrate by causing a pressing member to come into surface contact with a predetermined region of the first substrate. In addition, simultaneously with the application of the predetermined load or after the application of the predetermined load to the first substrate, in the state where the pressing member comes into surface contact with the first substrate, the first substrate is caused to come into contact with a second substrate.

According to another embodiment of the present disclosure, there is provided a substrate bonding apparatus configured to include a pressing member and a substrate driving unit, and the function of each unit is as follows. The pressing member comes into surface contact with a predetermined region of a first substrate, and applies a predetermined load to the first substrate. The substrate driving unit causes the first substrate to come into contact with a second substrate simultaneously with the application of the predetermined load or after the application of the predetermined load to the first substrate by the pressing member.

As described above, in the substrate bonding method and the substrate bonding apparatus according to the embodiments of the present disclosure, simultaneously with the application of the predetermined load or after the application of the load to the first substrate by the pressing member, in the state where the pressing member is caused to come into surface contact with the first substrate, the first substrate is caused to come into contact with the second substrate. According to the substrate bonding method and the substrate bonding apparatus according to the embodiments of the present disclosure, an alignment precision adjusted to a high precision between two substrates before bonding can be maintained even after bonding.

### BRIEF DESCRIPTION OF THE DRAWINGS

FIG. 1 is a schematic configuration diagram of a wafer bonding apparatus according to an embodiment of the present disclosure.

FIG. 2 is an outer appearance diagram of a pressing member used in the bonding apparatus according to the embodiment of the present disclosure.

FIG. 3 is a diagram illustrating the principle of suppressing a displacement of a wafer during temporary bonding.

FIG. 4 is a flowchart showing the order of a wafer bonding method according to the embodiment of the present disclosure.

FIGS. 5A to 5C are diagrams illustrating a method of temporary bonding during a low load.

FIGS. 6A to 6C are diagrams illustrating the method of temporary bonding during a high load.

FIG. 7 is an outer appearance diagram of a pressing member of Comparative Example.

FIG. 8 is a diagram illustrating load-dependent properties of an alignment precision when the pressing member of the Comparative Example is used.

FIG. 9 is a diagram illustrating load-dependent properties of an alignment precision in the bonding apparatus according to the embodiment of the present disclosure.

FIGS. 10A and 10B are schematic configuration diagrams of pressing members of Modified Example 1.

FIGS. 11A to 11C are schematic configuration diagrams of pressing members of Modified Example 2.

FIGS. 12A and 12B are schematic configuration diagrams of pressing members of Modified Example 3-1.

FIGS. 13A and 13B are schematic configuration diagrams of pressing members of Modified Example 3-2.

FIGS. 14A and 14B are schematic configuration diagrams of pressing members of Modified Example 3-3.

FIGS. 15A and 15B are schematic configuration diagrams of pressing members of Modified Example 4.

FIGS. 16A and 16B are schematic configuration diagrams of pressing members of Modified Example 6-1.

FIG. 17 is a schematic configuration diagram of a pressing member of Modified Example 6-2.

FIG. 18 is a schematic configuration diagram of a pressing member of Modified Example 6-3.

### DETAILED DESCRIPTION OF EMBODIMENTS

Hereinafter, an example of a substrate bonding method and a bonding apparatus according to an embodiment of the present disclosure will be described in order described as follows with reference to the drawings. However, the present disclosure is not limited to examples described later.

### 1. Basic Example of Substrate Bonding Apparatus and Bonding Method

### 2. Various Modified Examples

### 1. BASIC EXAMPLE OF SUBSTRATE BONDING APPARATUS AND BONDING METHOD

### Configuration of Bonding Apparatus

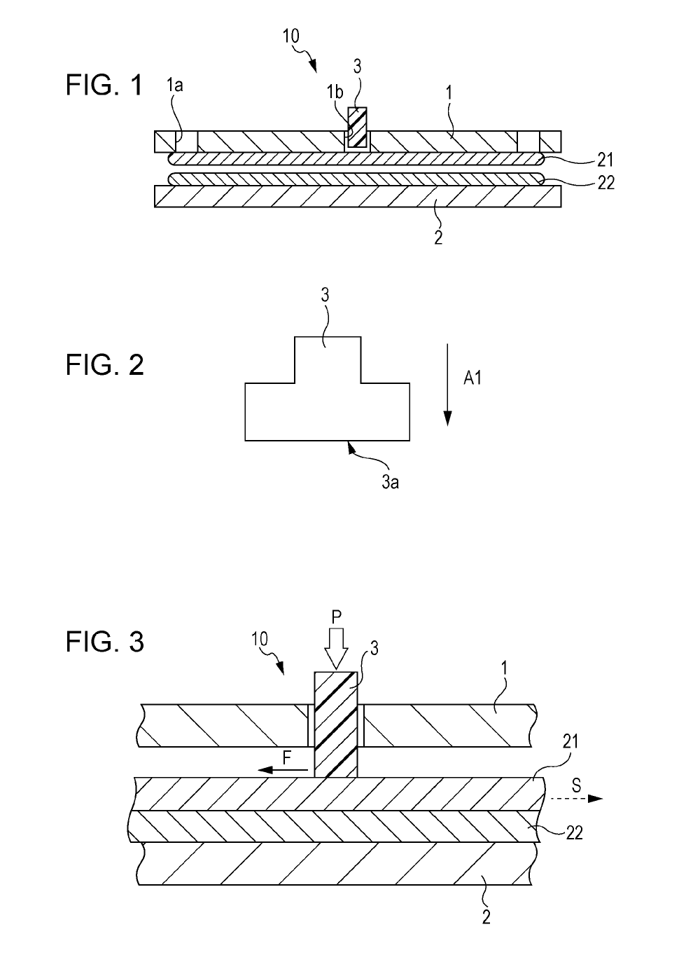

FIG. 1 shows a schematic configuration of a wafer bonding apparatus according to an embodiment of the present disclosure. In addition, in FIG. 1, for simplifying description, only main parts that function when two wafers are bonded to each other are shown. In addition, in FIG. 1, a form of a state in which two wafers to be bonded to each other are mounted in the bonding apparatus is shown.

A bonding apparatus 10 (substrate bonding apparatus) includes an upper chuck 1 (a substrate driving unit), a lower chuck 2, and a pressing member 3. In addition, in this embodiment, the bonding apparatus 10 of a type in which alignment of two Si wafers (substrates) of which the bonding side surfaces are activated is performed by an optical alignment method and the two Si wafers are subsequently bonded to each other will be described. Therefore, although not shown in FIG. 1, the bonding apparatus 10 of this embodiment also includes an optical alignment unit which performs alignment of two Si wafers.

The upper chuck 1 is a plate-like member that holds a Si wafer (an upper wafer 21 in FIG. 1) to be detachable. In the vicinity of the outer periphery of the upper chuck 1, a suction port 1a for subjecting the upper wafer 21 to vacuum suction is provided. Moreover, in the vicinity of the center of the upper chuck 1, a load application unit 1b which enables the pressing member 3 to move in the thickness direction of the upper chuck 1 is provided. In addition, in the example shown in FIG. 1, an example in which the load application unit 1b is configured as a through-hole is described. However, the present disclosure is not limited to this. The load application unit 1b may have an arbitrary configuration as long as the pressing member 3 is enabled to move in the thickness direction of the upper chuck 1 and a load can be applied to the upper wafer 21 by the pressing member 3.

The lower chuck 2 is a plate-like member which holds a Si wafer (a lower wafer 22 in FIG. 1) to be detachable. In addition, the lower chuck 2 has a holding unit for holding the lower wafer 22 although not shown in FIG. 1. In addition, the holding unit may be arbitrarily configured to have a configuration capable of holding the lower wafer 22, and for example, may be configured as a suction port for subjecting the lower wafer 22 to vacuum suction, a pin that holds the outer peripheral portion of the lower wafer 22, and the like.

The pressing member 3 is a member for applying a load to the upper wafer 21. Here, FIG. 2 shows the schematic configuration of the pressing member 3 used in this embodiment. The pressing member 3 is a bar-like member of which the cross-section in a direction along a load application direction (a pressing direction: the direction of the arrow A1 in FIG. 2) has a substantially T shape.

A pressing surface 3a (contact surface) of the pressing member 3 on a side coming into contact with the upper wafer 21 is a substantially flat surface and the surface shape thereof is substantially circular. In addition, the diameter, that is, the area of the pressing surface 3a is set to a value so that a frictional force at a degree so as not to allow the upper wafer 21 to cause a displacement of a rotating system with respect to the lower wafer 22 is generated between the pressing member 3 and the upper wafer 21 when the upper wafer 21 is caused to come into contact with the lower wafer 22. In addition, by increasing the diameter (area) of the pressing surface 3a, between the pressing member 3 and the upper wafer 21, a high frictional force is obtained in a rotation direction inside the surface of the upper wafer 21 with the center point of the contact surface of the pressing member 3 as the center. However, if the diameter of the pressing surface 3a is too great, voids are more likely to be generated in the vicinity of the center of the wafer during wafer bonding. Therefore, the diameter (area) of the pressing surface 3a is appropriately set also in consideration of the influence of the void generation.

The pressing member 3 may be formed of a resin material having a sufficient rigidity such as Teflon (registered trademark) or PEEK (polyetheretherketone). However, the forming material of the pressing member 3 is not limited to these examples, and may be appropriately changed in consideration of, for example, the area of the pressing surface 3a and the forming material of the upper wafer 21. In addition, the configuration such as the overall shape of the pressing member 3 and the shape and area of the pressing surface 3a is not limited to the example of this embodiment, and may be an arbitrary configuration as long as a frictional force having a magnitude described above is obtained between the pressing member 3 and the upper wafer 21 during bonding of the wafers.

### Principle of Suppressing Displacement of Upper Wafer

Next, in the bonding apparatus 10 of this embodiment, the principle of suppressing a displacement of the upper wafer 21 with respect to the lower wafer 22 which occurs when the upper wafer 21 is caused to come into contact with the lower wafer 22 will be described.

In the bonding apparatus 10 of this embodiment, in order to maintain the alignment precision before bonding even after bonding, after optical alignment, until temporary bonding by van der Waals forces is completed after two wafers are caused to come into contact with each other, a displacement between both the wafers has to be suppressed.

However, as a method for suppressing the displacement between two wafers when the two are caused to come into contact with each other, when a method of applying a load to a single point on the upper wafer 21 using the pressing member 3, for example, like the method of Japanese Unexamined Patent Application Publication No. 2006-269850, or the like is employed, the following problems occur.

In the typical load application method by single point pressurization, the pressing member 3 and the upper wafer 21 are in a point contact state, and air is present between the upper and lower wafers 21 and 22, such that it is difficult to hold the upper wafer 21, resulting in a difficulty in maintaining the alignment precision. Specifically, the upper wafer 21, for example, slides, rotates, or moves on the lower wafer 22 under its own weight, resulting in a reduction in the alignment precision. This problem can be solved by increasing the load applied to the upper wafer 21. However, when the load is too high, as indicated by Japanese Unexamined Patent Application Publication No. 2006-269850, problems such as a stress on the upper wafer 21 and the generation of voids occur.

In order to solve the problems as described above, in this embodiment, temporary bonding of two wafers is performed as follows. First, in the bonding apparatus 10 of this embodiment, after optical alignment between the upper and lower wafers 21 and 22 is performed, the pressing member 3 is caused to come into surface contact with the upper wafer 21 to apply a load thereto. Thereafter, simultaneously with the load application by the pressing member 3 or after the load application, vacuum suction of the upper wafer 21 is released, such that the upper wafer 21 is caused to come into contact with (is temporarily bonded to) the lower wafer 22.

In this embodiment, as described above, in order to suppress the displacement of the upper wafer 21 with respect to the lower wafer 22 which occurs during temporary bonding, the pressing member 3 is caused to come into surface contact with the upper wafer 21 to apply a load thereto. In addition, in this embodiment, the area of the pressing surface 3a of the pressing member 3 is set so that a frictional force at a degree so as not to allow the upper wafer 21 to cause a displacement with respect to the lower wafer 22 during a contact between both the wafers is generated between the pressing member 3 and the upper wafer 21. Therefore, in the bonding apparatus 10 of this embodiment, when the upper wafer 21 is caused to come into contact with the lower wafer 22, by the frictional force generated between the pressing member 3 and the upper wafer 21, the displacement between the upper and lower wafers 21 and 22 is suppressed.

Here, the principle of suppressing the displacement of the upper wafer 21 in this embodiment described above will be described more specifically with reference to FIG. 3. In addition, FIG. 3 is an enlarged view of contact parts of the pressing member 3 and the upper wafer 21 when the upper wafer 21 is caused to come into contact with the lower wafer 22 (during temporary bonding).

In the bonding apparatus 10 of this embodiment, during temporary bonding, first, a load P is applied to the upper wafer 21 by the pressing member 3 (the outline arrow in FIG. 3), and simultaneously with this, or after this, vacuum suction of the upper wafer 21 is released to cause the upper wafer 21 to come into contact with the lower wafer 22. Here, since air is present between the upper and lower wafers 21 and 22, the upper wafer 21 is apt to, for example, slide, rotate, or move on the lower wafer 22 under its own weight (the dashed arrow in FIG. 3).

However, here, the pressing member 3 comes into surface contact with the upper wafer 21 on the predetermined area described above. Therefore, during temporary bonding, between the pressing member 3 and the upper wafer 21, a frictional force F having a magnitude of equal to or greater than the displacement force S is exerted against a force S which is apt to move the upper wafer 21 on the lower wafer 22 (hereinafter, referred to as a displacement force S) (the solid arrow in FIG. 3). Accordingly, the movement of the upper wafer 21 on the lower wafer 22 is suppressed, so that the displacement of the upper wafer 21 is suppressed. As a result, in this embodiment, even after temporary bonding between the upper and lower wafers 21 and 22 is performed, alignment precision before the bonding can be maintained.

As apparent from the principle, in this embodiment, the configuration of the pressing member 3 such as the area and the forming material of the pressing surface 3a has to be set so that the frictional force F generated between the pressing member 3 and the upper wafer 21 is equal to or higher than the displacement force S generated between the wafers during temporary bonding. More specifically, since the frictional force F generated between the pressing member 3 and the upper wafer 21 is obtained by the coefficient of static friction×the normal force, the configuration of the pressing member 3 such as the forming material of the pressing surface 3a has to be appropriately set according to the forming material of the upper wafer 21 and the applied load.

In addition, as in this embodiment, in the bonding apparatus 10 of a type in which the upper wafer 21 is held by vacuum suction, as described above, vacuum suction of the upper wafer 21 is released to cause the upper wafer 21 to come into contact with the lower wafer 22. This is because voids are more likely to be generated in a case where the upper and lower wafers 21 and 22 are caused to come into contact with each other while being respectively fixed to the upper chuck 1 and the lower chuck 2. Here, as another method of suppressing the void generation during a contact of both wafers, there is a method of deforming one stage. However, in this method, the wafer on the stage is also deformed (warps). Therefore, in this method, since optical alignment is performed with a predetermined pattern in the deformed wafer, there is a disadvantage in that the alignment precision thereof is reduced.

### Bonding Method

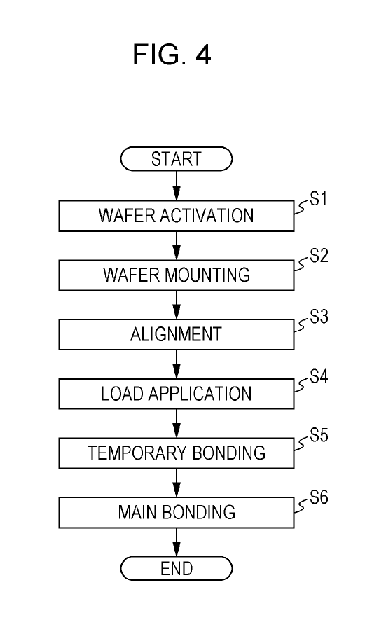

Next, a bonding method of Si wafers in the bonding apparatus 10 of this embodiment will be described with reference to FIG. 4. In addition, FIG. 4 is a flowchart showing the order of processes of the bonding method of Si wafers of this embodiment.

First, the upper and lower wafers 21 and 22 at a wafer level at which, for example, predetermined elements or wires are formed on a Si substrate are prepared. Thereafter, the bonding side surface of each wafer is subjected to chemical mechanical polishing (CMP) to planarize the surface.

Thereafter, the planarized bonding side surface of each wafer is activated (Step S1). Specifically, a hydrophilic process (for example, plasma irradiation, or DIW (Deionized Water) washing) is performed on the planarized bonding side surface of each wafer to generate an OH group (a hydroxyl group) on the bonding side surface of each wafer.

In addition, the activation process (Step S1) of each wafer may be performed at an arbitrary timing as long as the timing is before a temporary bonding process of the wafer. In addition, in this example, an example in which the activation process of each wafer is performed by an external apparatus before the upper and lower wafers 21 and 22 are mounted in the bonding apparatus 10 is described. However, the present disclosure is not limited to this. The activation process of each wafer may also be performed in the state where the upper and lower wafers 21 and 22 are mounted in the bonding apparatus 10.

Thereafter, the upper and lower wafers 21 and 22 activated as described above are respectively mounted on the upper chuck 1 and the lower chuck 2 in the bonding apparatus 10 (Step S2). Here, the upper chuck 1 holds the upper wafer 21 by vacuum suction via a suction port 21a, and the lower chuck 2 holds the lower wafer 22 by means of, for example, vacuum suction or a pin. In addition, here, the upper and lower wafers 21 and 22 are respectively mounted on the upper chuck 1 and the lower chuck 2 so that the activated surfaces of the upper and lower wafers 21 and 22 oppose each other.

Thereafter, the bonding apparatus 10 performs alignment between the upper and lower wafers 21 and 22 by an optical alignment method (Step S3). Specifically, a predetermined mark formed in the pattern of the upper wafer 21 and/or the lower wafer 22 or the pattern is optically detected, and alignment is performed on the basis of the detection result.

Thereafter, after terminating the alignment, the bonding apparatus 10 causes the pressing member 3 to come into contact (surface contact) with the upper wafer 21 and applies a predetermined load to the upper wafer 21 via the pressing member 3 (Step S4). Thereafter, the upper chuck 1 releases vacuum suction of the upper wafer 21 to cause the upper wafer 21 to come into contact with the lower wafer 22 (temporary bonding: Step S5). Here, the upper wafer 21 is apt to move on the lower wafer 22 under its own weight. However, the movement is suppressed by the frictional force generated between the pressing member 3 and the upper wafer 21, so that an alignment precision adjusted to a high precision is maintained by the optical alignment method.

In addition, in this embodiment, Step S4 of applying a predetermined load to the upper wafer 21 and Step S5 of releasing vacuum suction of the upper wafer 21 to cause the upper wafer 21 to come into contact with the lower wafer 22 may be simultaneously performed. In addition, in Steps S4 and S5, the pressing member 3 may also be driven by a gas pressure or mechanically driven. Moreover, in Step S5, when the upper wafer 21 is temporarily bonded to the lower wafer 22, the lower wafer 22 may be in a state of being held (fixed) by the lower chuck 2 or in a released state.

Thereafter, the bonding apparatus 10 performs annealing on the temporarily bonded upper and lower wafers 21 and 22 at a predetermined temperature for main bonding (Step S6), and terminates a bonding process. Here, the main bonding process of the upper and lower wafers 21 and 22 may be performed by performing an annealing process at a low temperature by, for example, plasma. In this embodiment, in this manner, the two wafers (the upper and lower wafers 21 and 22) at the wafer level at which, for example, predetermined elements or wires are formed on Si substrates are bonded to each other.

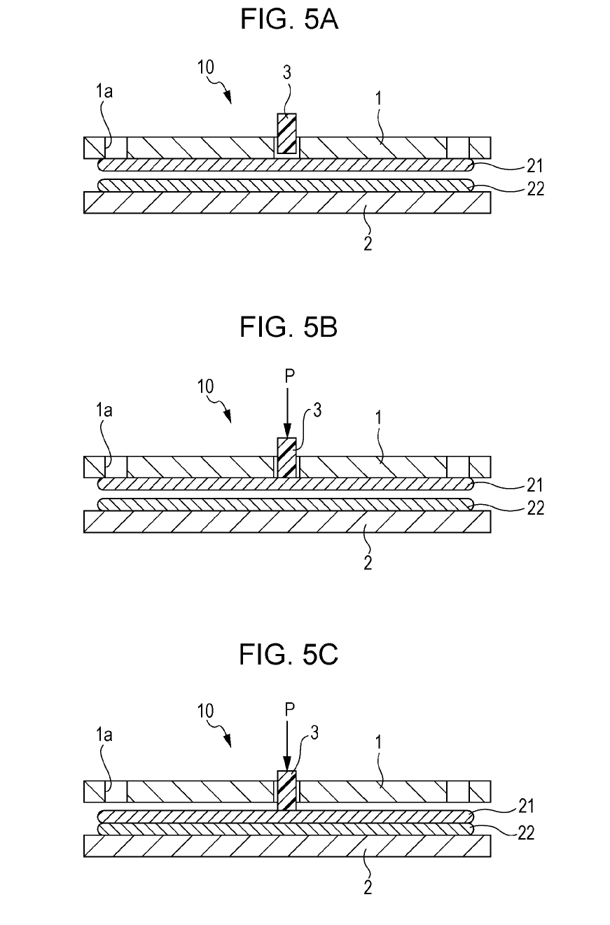

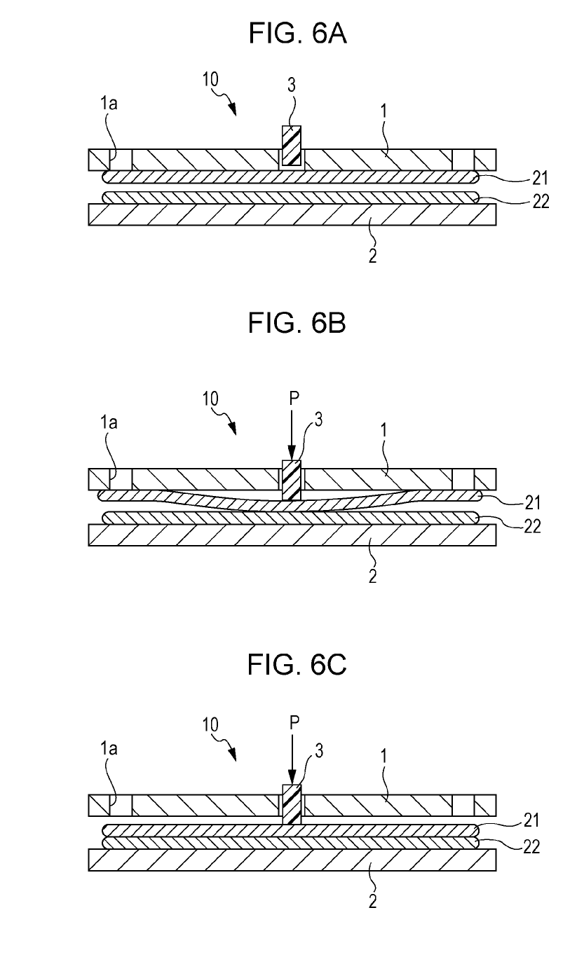

In addition, in the processes of Steps S4 and S5 described above, in a case of a relatively low load and in a case of a high load, the bonding procedure of the upper and lower wafers 21 and 22 is different. Here, the relationship between the applied load and the bonding procedure of the upper and lower wafers 21 and 22 will be described in detail using FIGS. 5A to 5C and FIGS. 6A to 6C.

FIGS. 5A to 5C are diagrams illustrating forms of a bonding procedure of the upper and lower wafers 21 and 22 when the two are temporarily bonded to each other at a low load. Specifically, FIGS. 5A, 5B, and 5C are diagrams illustrating the states of the upper and lower wafers 21 and 22 before load application, during load application, and during release of vacuum suction, respectively. On the other hand, FIGS. 6A to 6C are diagrams illustrating forms of a bonding procedure of the upper and lower wafers 21 and 22 when the two are temporarily bonded to each other at a high load. Specifically, FIGS. 6A, 6B, and 6C are diagrams illustrating the states of the upper and lower wafers 21 and 22 before load application, during load application, and during release of vacuum suction, respectively.

In a case where a low load is applied to the upper wafer 21 by the pressing member 3, as shown in FIG. 5B, at a load application time point (Step S4), the upper wafer 21 is hardly deformed and does not come into contact with the lower wafer 22. In this case, as shown in FIG. 5C, when the vacuum suction of the upper wafer 21 is released (Step S5), the upper wafer 21 comes into contact with the lower wafer 22 at first.

On the other hand, in a case where a high load is applied to the upper wafer 21 by the pressing member 3, as shown in FIG. 6B, at a load application time point (Step S4), a load application region of the upper wafer 21 is deformed and comes into contact with the lower wafer 22. That is, in this case, as shown in FIG. 6C, before the vacuum suction of the upper wafer 21 is released and the entire upper wafer 21 comes into contact with the lower wafer 22 (Step S5), the load application region of the upper wafer 21 comes into contact with the lower wafer 22. In this case, since temporary bonding is performed in the state where the load application region comes into contact in advance, generation of a displacement of the upper wafer 21 can be further suppressed.

### Evaluation of Alignment Precision

Next, the evaluation of alignment precision after temporary bonding performed in this embodiment will be described. In addition, in the evaluation, alignment errors (displacement amounts) after temporary bonding under various loads were measured, and load-dependent properties of the alignment precision were examined. Specifically, the load-dependent properties of the alignment precision were examined by changing a load to 8 N, 15 N, and 30 N. Here, in the evaluation, the diameter of the pressing surface 3a of the pressing member 3 was set to 4.5 mm.

In addition, here, for the comparison to the evaluation result of this embodiment, evaluation of alignment precision in a case where a pressing member (a comparative example) having a pressing surface which comes into point contact with the upper wafer 21 was also performed.

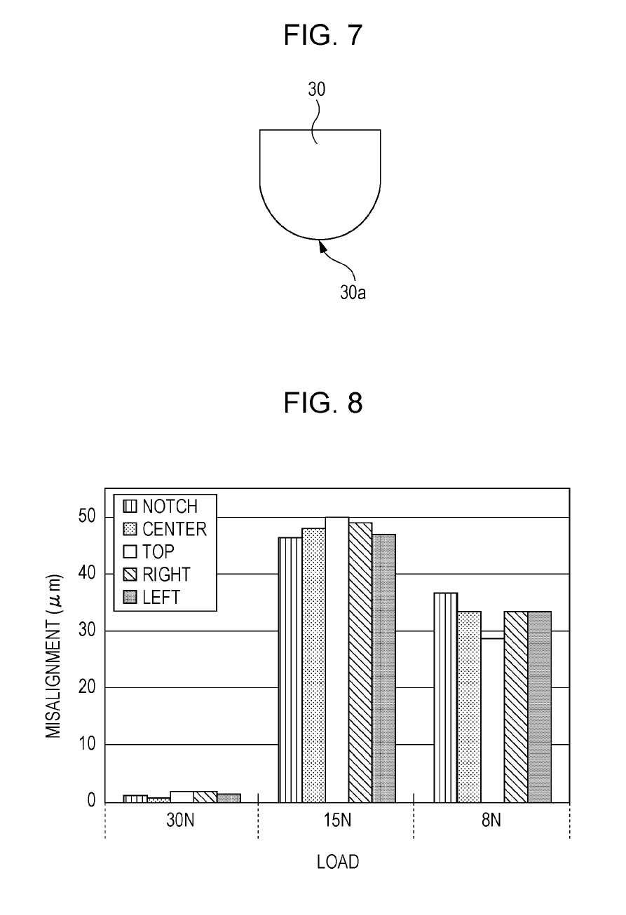

FIG. 7 shows a schematic configuration of the pressing member of the comparative example used in the evaluation. As a pressing member 30 of the comparative example, a bar-like member was used and the tip end surface (a pressing surface 30a) thereof was a spherical surface having a convex shape. In addition, to the pressing member 30 of the comparative example shown in FIG. 7, loads of 8 N, 15 N, and 30 N were applied, and the evaluation of an alignment precision under each load was performed.

FIG. 8 shows the evaluation results of the comparative example. The horizontal axis of properties (alignment properties) of the bar graphs shown in FIG. 8 represents the value of each verified load, and the vertical axis thereof represents an alignment error.

In addition, the bar graph of “Notch” shown in FIG. 8 represents alignment properties of the vicinity of a notch portion (a cutout portion) of a Si wafer. The bar graph of “Center” shown in FIG. 8 represents alignment properties of the vicinity of the center portion of the Si wafer. The bar graph of “Top” shown in FIG. 8 represents alignment properties of the vicinity of an end portion (a top portion) opposing the notch portion of the Si wafer with the center of the Si wafer interposed therebetween. The bar graph of “Right” shown in FIG. 8 represents alignment properties of a part positioned in the vicinity of the shortest portion on the right of the Si wafer with respect to a line segment between the notch portion and the top portion when the notch portion of the Si wafer is directed downward and the top portion is directed upward. In addition, the bar graph of “Left” shown in FIG. 8 represents alignment properties of a part positioned in the vicinity of the shortest portion on the left of the Si wafer with respect to a line segment between the notch portion and the top portion when the notch portion of the Si wafer is directed downward and the top portion is directed upward.

As apparent from FIG. 8, in the comparative example, when the load was 8 N and 15 N, alignment errors were significantly increased (equal to or higher than 30 μm) at all the verified spots (“Notch”, “Center”, “Top”, “Right”, and “Left”) in the Si wafer. In addition, in the comparative example, when the load was 30 N, the alignment error was equal to or less than about 1.5 μm. In addition, it was found that since the alignment precision of the optical alignment in the bonding apparatus 10 used in the verification was ±1.5 μm, in the comparative example, in order to maintain the alignment precision before temporary bonding, a high load of 30 N has to be applied to the wafer.

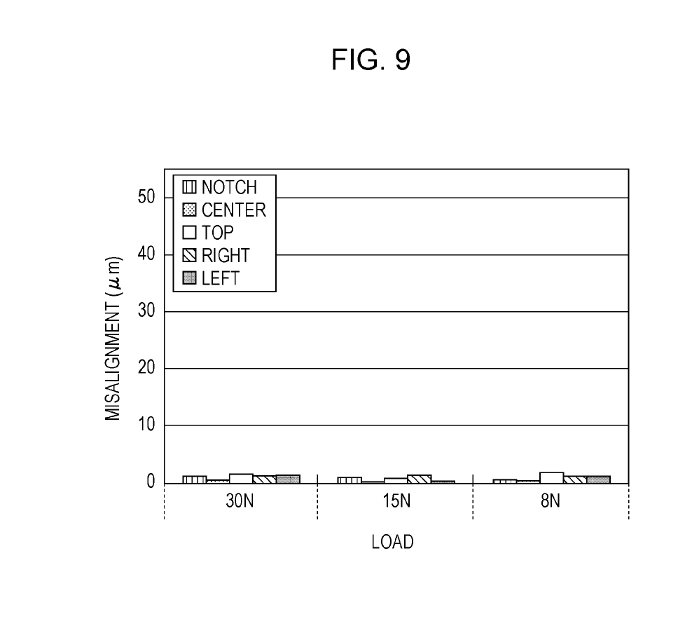

Next, the evaluation results of this embodiment will be described. FIG. 9 shows the evaluation results of this embodiment. The horizontal axis of properties of the bar graphs shown in FIG. 9 represents the value of each verified load, and the vertical axis thereof represents an alignment error. In addition, FIG. 9 shows, as in FIG. 8, the evaluation results of the alignment precisions measured at each of the verified spots (“Notch”, “Center”, “Top”, “Right”, and “Left”) in the Si wafer.

In this embodiment, when the load was 15 N and 30 N, the alignment error was equal to or less than about 1.5 μm at all the verified spots in the Si wafer. In addition, in this embodiment, even when the load was 8 N, the alignment error was equal to or less than 2 μm. That is, it was found that, in this embodiment, compared to the comparative example, regardless of load (even under a low load), the alignment precision adjusted to a high precision before temporary bonding could be sufficiently maintained even after temporary bonding.

### 2. VARIOUS MODIFIED EXAMPLES

The configuration of the pressing member that may be used in the bonding apparatus of the present disclosure is not limited to the configuration of the embodiment, and various modified examples are considered. Hereinafter, various modified examples of the pressing member will be described. In addition, in the various modified examples described later, as in the embodiment (FIG. 2), an example of the pressing member configured as a bar-like member of which the cross-section in a direction along the pressing direction (the direction of the arrow A1 in FIG. 2) has a substantially T shape is described. However, the present disclosure is not limited to this. The configuration (for example, the shape and the like) of the pressing member represented in the various modified examples described later may be an arbitrary configuration as long as a force (frictional force or adsorption force described later) that is equal to or higher than the displacement force exerted between the wafers described in the embodiment is generated between the pressing member and the upper wafer during temporary bonding of the wafers.

### Modified Example 1

In the embodiment, an example in which the pressing member 3 is formed of a resin material such as Teflon or PEEK is described. However, the present disclosure is not limited to this. For example, the pressing member may be formed of a metal material, or only the pressing surface of the pressing member may be formed of a metal material. In Modified Example 1, the configuration example of such a pressing member will be described.

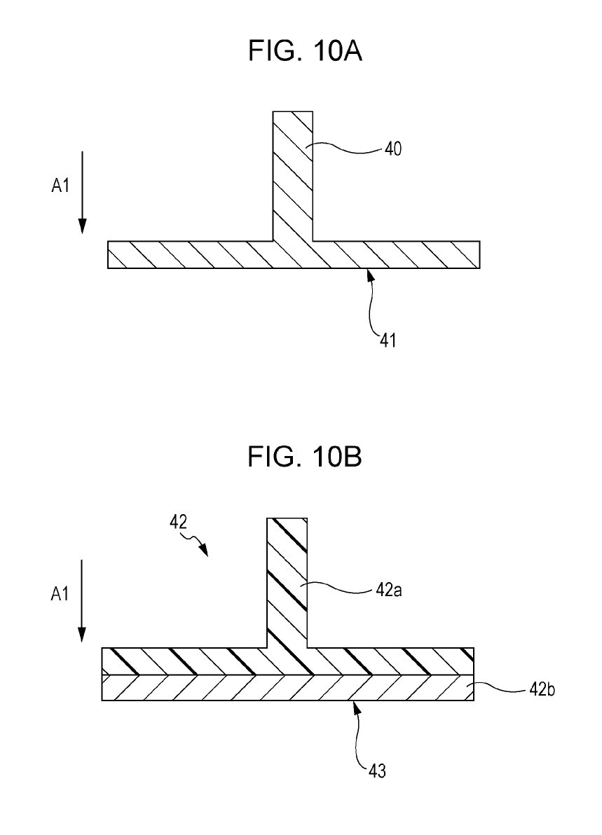

FIGS. 10A and 10B show the schematic configuration of a pressing member of Modified Example 1. In addition, FIGS. 10A and 10B are schematic cross-sectional views in a direction along the pressing direction of the pressing member.

With regard to the pressing member 40 shown in FIG. 10A, the entire pressing member 40 is formed of a metal material such as aluminum or stainless steel. In addition, the pressing member 40 shown in FIG. 10A may be configured like the pressing member 3 (FIG. 2) of the embodiment except that the forming material is a metal.

A pressing member 42 shown in FIG. 10B is configured of a pressing member main body 42a and a metal material portion 42b.

The pressing member main body 42a may be formed of, for example, a hard resin material like the pressing member 3 (FIG. 2) of the embodiment. The metal material portion 42b is provided on the surface of the pressing member main body 42a on a pressing surface 43 side and is configured as a metal plate or a metal film. In addition, the pressing member 42 shown in FIG. 10B may be configured like the pressing member 3 (FIG. 2) of the embodiment except that the metal material portion 42b is provided on the surface of the pressing member main body 42a on the pressing surface 43 side.

Even in this example, by appropriately setting the areas and the shapes of the pressing surfaces 41 and 43 so that the frictional force generated between the pressing members 40 and 42 and the upper wafer is equal to or higher than the displacement force generated between the wafers during temporary bonding, the same effect as that in the embodiment is obtained.

Moreover, in the pressing members 40 and 42 of this example, since the pressing surfaces 41 and 43 are formed of a metal harder than a material such as a resin, deformation of the pressing surfaces 41 and 43 when the upper wafer is pressed by the pressing members 40 and 42 can be further reduced. In this case, uniformity of the pressing force in the pressing region (contact region) can be further enhanced.

In addition, in this example, the example in which the pressing member 40 and the pressing surface 43 of the pressing member 42 are formed of the metal material is described. However, the present disclosure is not limited to this, and an arbitrary material may be used as long as the material is a hard material capable of further reducing deformation of the pressing surface when the upper wafer is pressed. For example, the pressing member 40 and the pressing surface 43 of the pressing member 42 may be formed of a ceramic material.

### Modified Example 2

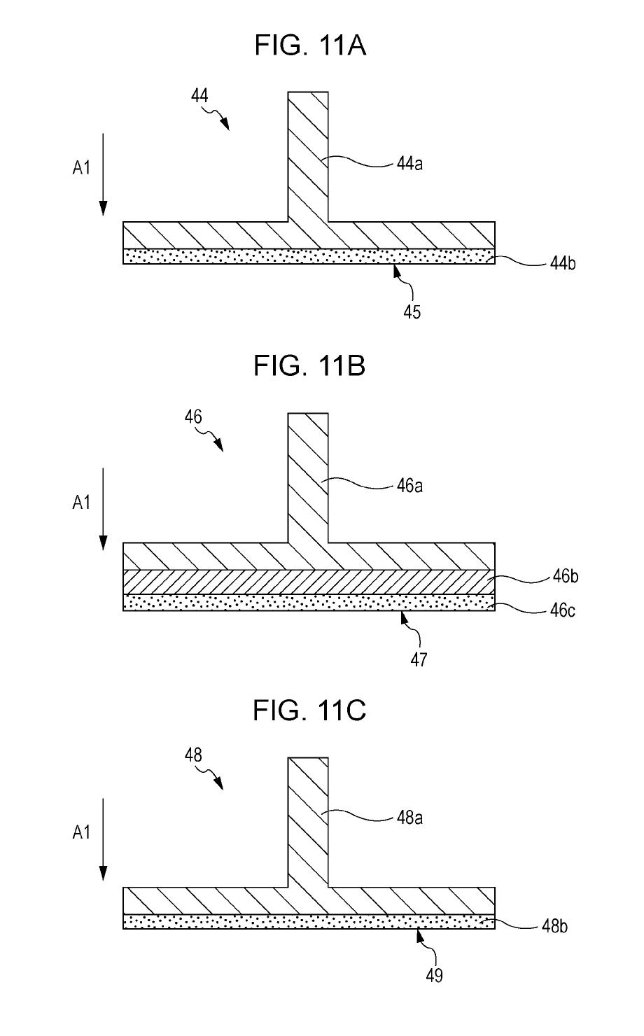

In Modified Example 2, an example in which the pressing surface of the pressing member is formed of an elastic material such as a rubber is described. FIGS. 11A to 11C show the schematic configuration of the pressing member of Modified Example 2. In addition, FIGS. 11A to 11C are schematic cross-sectional views in a direction along the pressing direction of the pressing member.

A pressing member 44 shown in FIG. 11A is configured of a pressing member main body 44a and an elastic material portion 44b.

The pressing member main body 44a may be formed of, for example, a hard resin material like the pressing member 3 (FIG. 2) of the embodiment. The elastic material portion 44b is provided on the surface of the pressing member main body 44a on a pressing surface 45 side and is configured as a plate-like (layer-like) member made of a material such as a rubber. In addition, the pressing member 44 shown in FIG. 11A may be configured like the pressing member 3 (FIG. 2) of the embodiment except that the elastic material portion 44b is provided on the surface of the pressing member main body 44a on the pressing surface 45 side.

A pressing member 46 shown in FIG. 11B is configured of a pressing member main body 46a, a metal material portion 46b, and an elastic material portion 46c.

The pressing member main body 46a has the same configuration as the pressing member main body 44a shown in FIG. 11A. The metal material portion 46b is provided on the surface of the pressing member main body 46a on a pressing surface 47 side and is configured as a metal plate or a metal film. The elastic material portion 46c is provided on the surface of the metal material portion 46b on the pressing surface 47 side and is configured as a plate-like (layer-like) member made of a material such as a rubber. That is, the pressing member 46 has a configuration in which the metal material portion 46b is provided between the pressing member main body 44a and the elastic material portion 44b in the pressing member 44 shown in FIG. 11A, and other configurations are the same as those of the pressing member 44 shown in FIG. 11A.

In addition, a pressing member 48 shown in FIG. 11C is configured of a pressing member main body 48a and an elastic material portion 48b.

The pressing member main body 48a is formed of a metal material. The elastic material portion 48b is provided on the surface of the pressing member main body 48a on a pressing surface 49 side and is configured as a plate-like (layer-like) member made of a material such as a rubber. That is, the pressing member 48 has a configuration in which the forming material of the pressing member main body 44a is changed to a metal in the pressing member 44 shown in FIG. 11A, and other configurations are the same as those of the pressing member 44 shown in FIG. 11A.

Even in this example, by appropriately setting the areas and the shapes of the pressing surfaces 45, 47, and 49 so that the frictional forces generated between the pressing members 44, 46, and 48 and the upper wafer are equal to or higher than the displacement force generated between the wafers during temporary bonding, the same effect as that in the embodiment is obtained.

Moreover, in this example, since the pressing surfaces 45, 47, and 49 are formed of an elastic material such as a rubber, a higher frictional force can be more easily generated between each of the pressing members and the upper wafer.

### Modified Example 3

In the bonding apparatus of this embodiment, as described above, the frictional force generated between the pressing member and the upper wafer is caused to be equal to or higher than the displacement force generated between the wafers during temporary bonding. Therefore, in order to obtain a desired frictional force between the pressing member and the upper wafer, it is preferable that the entire pressing surface of the pressing member come into contact with the upper wafer when the pressing member is caused to come into contact with the upper wafer. In order to realize this state, it is preferable that the pressing surface of the pressing member be parallel with the surface of the upper wafer. However, in practice, due to influences such as warpage of the upper wafer or mounting precision of the pressing member, there may be cases where the pressing surface of the pressing member is not sufficiently parallel with the surface of the upper wafer. In this case, the contact area between the pressing member and the upper wafer is reduced, and there is a possibility that a desired frictional force between the two is not obtained. Here, in Modified Example 3, various configuration examples of the pressing member that can solve the problems as described above will be described.

### (1) Modified Example 3-1

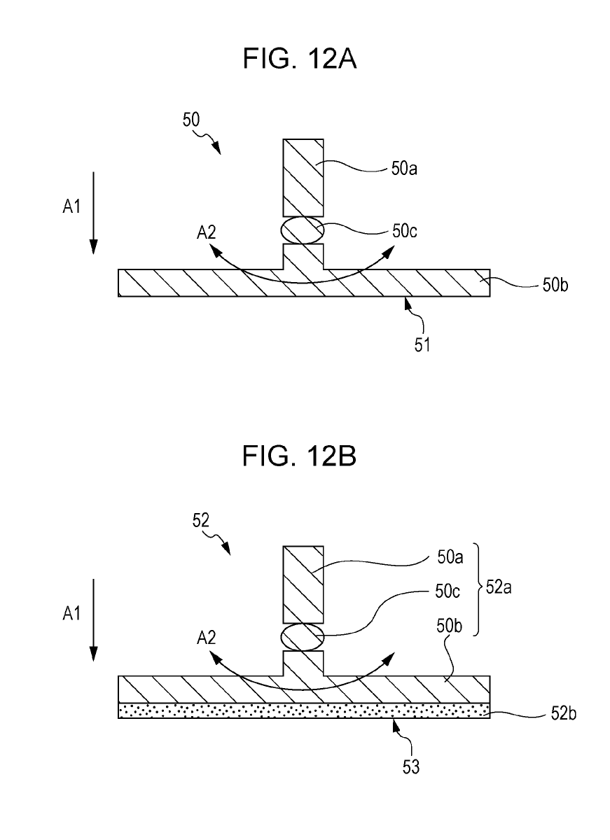

FIGS. 12A and 12B show the schematic configuration of a pressing member of Modified Example 3-1. In addition, FIGS. 12A and 12B are schematic cross-sectional views of pressing members in a direction along the pressing direction.

The pressing member 50 shown in FIG. 12A is configured of a support portion 50a, a pressing portion 50b, a connection portion 50c connecting the support portion 50a and the pressing portion 50b.

The support portion 50a is configured as a bar-like member extending in the pressing direction (the direction of the arrow A1 of FIG. 12A). In addition, one end portion of the support portion 50a is connected to the connection portion 50c. In addition, the support portion 50a may be formed of an arbitrary material as long as the material has a sufficient rigidity, and may be formed of a material such as a metal or a hard resin.

The pressing portion 50b is a substantially plate-like member in which one surface thereof is configured as a flat surface and the other surface thereof is configured as a convex surface. In addition, the one surface becomes a pressing surface 51, and the tip end of the convex portion of the other surface is connected to the connection portion 50c. In addition, the pressing portion 50b may be formed of an arbitrary material as long as the material has a sufficient rigidity, and may be formed of a material such as a metal or a hard resin. The pressing portion 50b may be formed of the same material as or a different material from that of the support portion 50a.

The connection portion 50c has a spherical member and connects the support portion 50a and the pressing portion 50b via the spherical member. Here, the pressing portion 50b is mounted on the connection portion 50c so as to be rotatable about the spherical member of the connection portion 50c (rotatable in the arrow A2 direction in FIG. 12A) as the fulcrum. That is, in the pressing member 50 in this embodiment, the support portion 50a and the pressing portion 50b have a ball joint configuration by the connection portion 50c. In addition, the connection portion 50c may be formed of an arbitrary material as long as the material has a sufficient rigidity and does not interrupt the rotation operation of the pressing portion 50b, and may be formed of a material such as a metal or a hard resin.

The pressing member 52 shown in FIG. 12B is configured of a pressing member main body 52a and an elastic material portion 52b. In addition, in the pressing member 52 shown in FIG. 12B, like elements that are the same as those in the pressing member 50 shown in FIG. 12A are denoted by like reference numerals.

The pressing member main body 52a has the same configuration as that of the pressing member 50 shown in FIG. 12A and is configured of the support portion 50a, the pressing portion 50b, and the connection portion 50c.

The elastic material portion 52b is provided on the surface of the pressing portion 50b on a pressing surface 53 side and is configured as a plate-like (layer-like) member made of a material such as a rubber. In addition, the pressing member 52 shown in FIG. 12B may be configured like the pressing member 50 shown in FIG. 12A except that the elastic material portion 52b is provided on the surface of the pressing portion 50b on the pressing surface 53 side.

The pressing members 50 and 52 in this example have a configuration in which, as described above, the pressing portion 50b is rotatable about the spherical member of the connection portion 50c as the fulcrum. Therefore, in a case where the pressing surfaces 51 and 53 are not parallel with the surface of the upper wafer, as the pressing surfaces 51 and 53 are caused to come into contact with the upper wafer, the pressing surfaces 51 and 53 rotate about the spherical member of the connection portion 50c as the fulcrum, so that the entire surfaces of the pressing surfaces 51 and 53 come into contact with the surface of the upper wafer. As a result, in this example, even in the case where the pressing surfaces 51 and 53 are not parallel with the surface of the upper wafer, the contact areas between the pressing members 50 and 52 and the upper wafer become desired areas, so that a desired frictional force between the two can be obtained. That is, in this example, even in the case where the pressing surfaces 51 and 53 are not parallel with the surface of the upper wafer, the displacement of the upper wafer can be more reliably prevented.

### (2) Modified Example 3-2

In Modified Example 3-1, the example in which the support portion 50a and the pressing portion 50b have the ball joint configuration via the connection portion 50c is described. However, the present disclosure is not limited to this, and for example, the support portion and the pressing portion may have a directly connected configuration. In Modified Example 3-2, a configuration example of such a pressing member will be described.

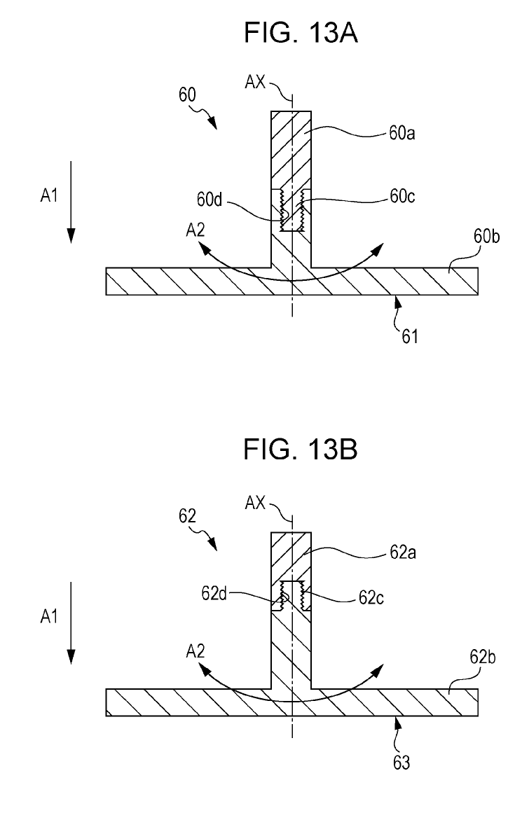

FIGS. 13A and 13B show the schematic configurations of pressing members of Modified Example 3-2. In addition, FIGS. 13A and 13B are schematic cross-sectional views of the pressing members in the direction along the pressing direction.

A pressing member 60 shown in FIG. 13A is configured of a support portion 60a and a pressing portion 60b.

The support portion 60a is configured as a bar-like member extending in the pressing direction (the arrow A1 direction of FIG. 13A). In addition, one end portion of the support portion 60a is provided with a male threaded portion 60c. In addition, the support portion 60a may be formed of an arbitrary material having flexibility and elasticity, and may be formed of a material such as a resin.

The pressing portion 60b is a substantially plate-like member in which one surface thereof is configured as a flat surface and the other surface thereof is configured as a convex surface. In addition, the one surface becomes a pressing surface 61, and the tip end of the convex portion of the other surface is connected to the support portion 60a. In addition, the tip end of the convex portion of the other surface of the pressing portion 60b is provided with a female threaded portion 60d fitted to the male threaded portion 60c of the support portion 60a. In addition, the pressing portion 60b may be formed of an arbitrary material having a sufficient rigidity, and may be formed of a material such as a metal or a hard resin.

In addition, in the pressing member 60 shown in FIG. 13A, the male threaded portion 60c of the support portion 60a is screwed to the female threaded portion 60d of the pressing portion 60b, such that the two are connected to each other.

A pressing member 62 shown in FIG. 13B is configured of a support portion 62a and a pressing portion 62b.

The support portion 62a is configured as a bar-like member extending in the pressing direction (the direction of the arrow A1 of FIG. 13B). Here, in the pressing member 62 shown in FIG. 13B, one end portion of the support portion 62a is provided with a female threaded portion 62c. In addition, the support portion 62a may be formed of an arbitrary material having flexibility and elasticity, and may be formed of a material such as a resin.

The pressing portion 62b is a substantially plate-like member in which one surface thereof is configured as a flat surface and the other surface thereof is configured as a convex surface. In addition, the one surface becomes a pressing surface 63, and the tip end of the convex portion of the other surface is connected to the support portion 62a. In addition, in the pressing member 62 shown in FIG. 13B, the tip end of the convex portion of the other surface of the pressing portion 62b is provided with a male threaded portion 62d fitted to the female threaded portion 62c of the support portion 62a. In addition, the pressing portion 62b may be formed of an arbitrary material having a sufficient rigidity, and may be formed of a material such as a metal or a hard resin.

In addition, in the pressing member 62 shown in FIG. 13B, the male threaded portion 62d of the pressing portion 62b is screwed to the female threaded portion 62c of the support portion 62a, such that the two are connected to each other.

In the pressing members 60 and 62 in this example, the pressing portions 60b and 62b are rotatable (rotatable in the arrow A2 direction of FIGS. 13A and 13B) about the center axis (the dot-dashed line AX in FIGS. 13A and 13B) of the support portions 60a and 62a having flexibility and elasticity. Therefore, in a case where the pressing surfaces 61 and 63 are not parallel with the surface of the upper wafer, as the pressing surfaces 61 and 63 are caused to come into contact with the upper wafer, the pressing surfaces 61 and 63 rotate about the center axis of the support portions 60a and 62a, so that the entire surfaces of the pressing surfaces 61 and 63 come into contact with the surface of the upper wafer. As a result, in this example, even in the case where the pressing surfaces 61 and 63 are not parallel with the surface of the upper wafer, the contact areas between the pressing members 60 and 62 and the upper wafer become desired areas, so that a desired frictional force between the two can be obtained. That is, even in this example, the same effect as that of Modified Example 3-1 is obtained.

### (3) Modified Example 3-3

In Modified Example 3-3, a configuration example in which the configuration of Modified Example 2 is further combined with the pressing members described in Modified Example 3-2 will be described.

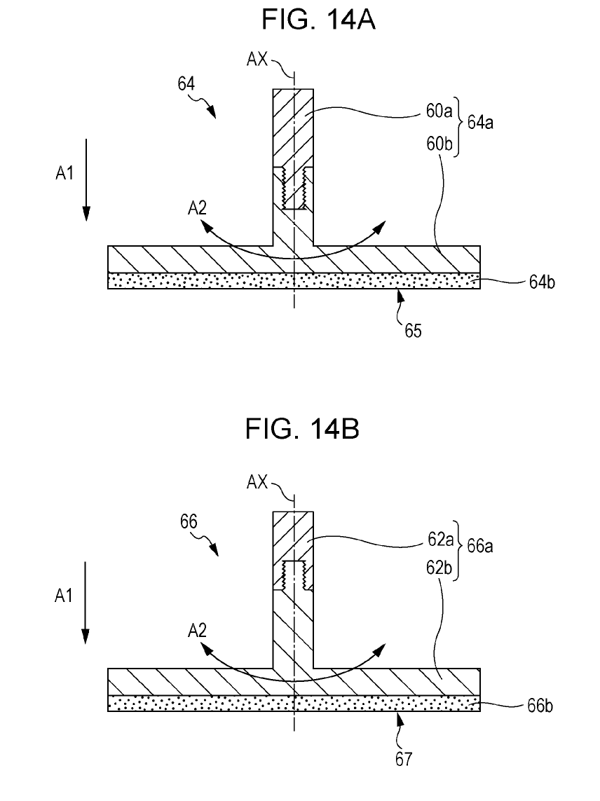

FIGS. 14A and 14B show the schematic configurations of the pressing members of Modified Example 3-3. FIGS. 14A and 14B are schematic cross-sectional views of the pressing members in the direction along the pressing direction. In addition, in pressing members 64 and 66 respectively shown in FIGS. 14A and 14B, like elements that are the same as those in the pressing members 60 and 62 of Modified Example 3-2 respectively shown in FIGS. 13A and 13B are denoted by like reference numerals.

The pressing member 64 shown in FIG. 14A is configured of a pressing member main body 64a and an elastic material portion 64b.

The pressing member main body 64a is configured of the support portion 60a and the pressing portion 60b. Since the pressing member main body 64a has the same configuration as that of the pressing member 60 shown in FIG. 13A, here, description of the configuration of each portion of the pressing member main body 64a will be omitted. The elastic material portion 64b is provided on the surface of the pressing portion 60b on a pressing surface 65 side and is configured as a plate-like (layer-like) member made of a material such as a rubber.

The pressing member 66 shown in FIG. 14B is configured of a pressing member main body 66a and an elastic member material 66b.

The pressing member main body 66a is configured of the support portion 62a and the pressing portion 62b. Since the pressing member main body 66a has the same configuration as that of the pressing member 62 shown in FIG. 13B, here, description of the configuration of each portion of the pressing member main body 66a will be omitted. The elastic material portion 66b is provided on the surface of the pressing portion 62b on a pressing surface 67 side and is configured as a plate-like (layer-like) member made of a material such as a rubber.

In the pressing members 64 and 66 in this example, the pressing surfaces 65 and 67 are rotatable (rotatable in the arrow A2 direction of FIGS. 14A and 14B) about the center axis (the dot-dashed line AX in FIGS. 14A and 14B) of the support portions 60a and 62a having flexibility and elasticity. Therefore, in this example, the same effect as that of Modified Example 3-2 is obtained. Moreover, in this example, since the pressing surfaces 65 and 67 are formed of an elastic material such as a rubber, a higher frictional force can be more easily generated between the pressing members 64 and 66 and the upper wafer.

In addition, in the example shown in FIGS. 14A and 14B, the example in which the configuration of Modified Example 2 is combined with the pressing members of Modified Example 3-2 is shown. However, the present disclosure is not limited to this. The configuration of Modified Example 2 may be combined with the pressing members of Modified Example 3-1, and in this case, the same effect as that of Modified Example 3-3 is also obtained.

### Modified Example 4

In this embodiment and the various modified examples, an example in which the shape of the pressing surface (contact surface) of the pressing member is circular is described. However, the present disclosure is not limited to this. The shape of the pressing surface may be arbitrarily set as long as a contact area that causes the frictional force generated between the pressing member and the upper wafer to be equal to or higher than the displacement force generated between the wafers during temporary bonding is obtained.

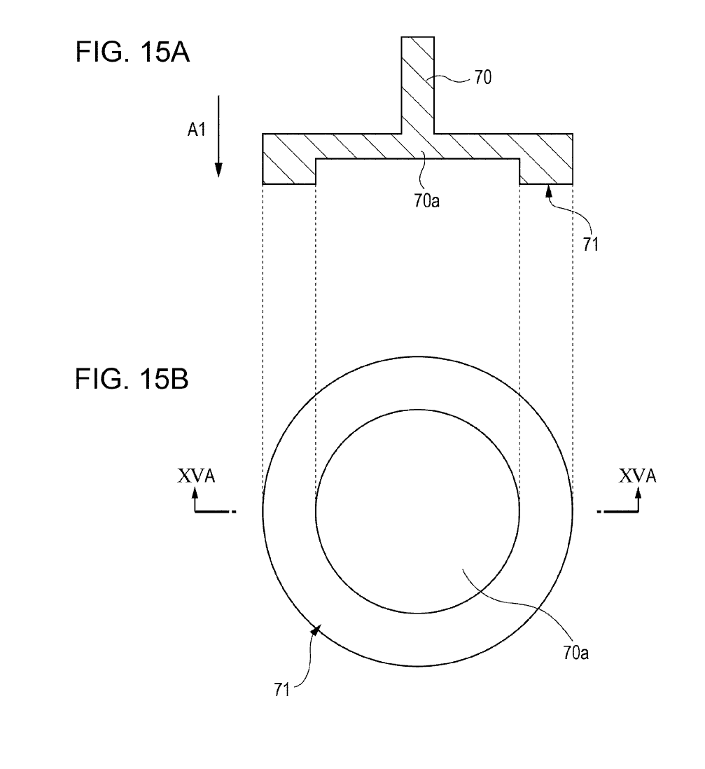

For example, the shape of the pressing surface may be a ring shape. A configuration example thereof is shown in FIGS. 15A and 15B. In addition, FIG. 15A is a schematic cross-sectional view of the pressing member in the direction along the pressing direction (the direction of the arrow A1 in FIG. 15A), and more specifically, is a cross-sectional view taken along the line XVA-XVA of FIG. 15B. FIG. 15B is a bottom view of the pressing member viewed from the pressing surface side.

In a pressing member 70 of this example, the center part of the surface on a pressing surface 71 side is provided with a concave portion 70a of which the opening is circular. Accordingly, the ring-shaped pressing surface 71 is formed. In addition, the pressing member 70 in this example may be formed of a material having a sufficient rigidity such as a metal or a hard resin, like the pressing member 3 (FIG. 2) of the embodiment.

In this example, the outside diameter of the pressing surface 71 and the width of the pressing surface 71 in a radial direction are appropriately controlled so that the frictional force generated between the pressing member 70 and the upper wafer is equal to or higher than the displacement force generated between the wafers during temporary bonding. Accordingly, even in this example, the same effect as that of the embodiment is obtained. In addition, the configuration of the pressing member of Modified Example 4 is not limited to the example shown in FIGS. 15A and 15B, and for example, may be a combination of the configuration of Modified Example 4 and at least one of the configurations of Modified Examples 1 to 3.

### Modified Example 5

In the embodiment and the various modified examples, the example in which the pressing surface (contact surface) of the pressing member is formed of a continuous region is described. However, the present disclosure is not limited to this, and the pressing surface of the pressing member may be configured of a plurality of independent regions (Modified Example 5).

For example, a configuration in which the upper wafer is pressed at a plurality of surface regions (multiple points) using a plurality of pressing members may be employed. In this case, the total value of the area of the plurality of pressing surfaces are set to a contact area that causes the frictional force generated between the pressing member and the upper wafer to be equal to or higher than the displacement force generated between the wafers during temporary bonding, thereby obtaining the same effect as that of the embodiment.

In addition, as each pressing member in this example, the pressing members having the same configurations as those of the embodiment and various modified examples may be used. However, in this case, the area of the pressing surface of each pressing member may be an area that causes the frictional force generated between each pressing member and the upper wafer to be smaller than the displacement force generated between the wafers during temporary bonding.

In addition, like this example, in the case where the upper wafer is pressed using the plurality of pressing members, in terms of void suppression, it is preferable that the plurality of pressing members be disposed at positions in point symmetry with respect to the center of the upper wafer.

### Modified Example 6

In the embodiment and various modified examples, the example in which the displacement of the upper wafer during temporary bonding is suppressed by the frictional force between the pressing member and the upper wafer is described. However, the present disclosure is not limited to this. For example, the displacement of the upper wafer may be suppressed by adsorbing the upper wafer onto the pressing member. That is, an adsorption force may be used as a suppression force for the displacement of the upper wafer during temporary bonding. In Modified Example 6, various configuration examples of the pressing member capable of adsorbing the upper wafer will be described.

### (1) Modified Example 6-1

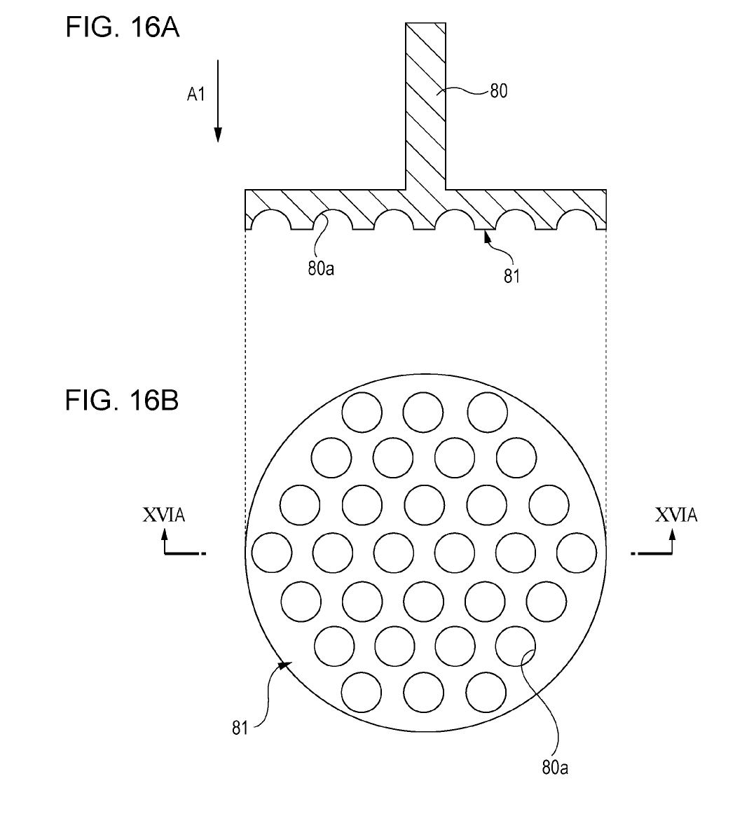

In Modified Example 6-1, a configuration example of the pressing member in which suckers are provided on the pressing surface of the pressing member and the upper wafer is adsorbed onto the pressing member will be described. FIGS. 16A and 16B show the schematic configuration of the pressing member of Modified Example 6-1. In addition, FIG. 16A is a schematic cross-sectional view of the pressing member in the direction along the pressing direction (the direction of the arrow A1 in FIG. 16A), and more specifically, is a cross-sectional view taken along the line XVIA-XVIA of FIG. 16B. FIG. 16B is a bottom view of the pressing member viewed from the pressing surface side.

A pressing member 80 in this example, like the embodiment, may be formed of a material having a sufficient rigidity such as a metal or a hard resin. In addition, in this example, a plurality of concave portions 80a are provided in a pressing surface 81 of the pressing member 80. In addition, the plurality of concave portions 80a are formed over the entire surface of pressing surface 81 at predetermined intervals.

The surface shape of each concave portion 80a is spherical. In addition, the size (the diameter and depth) of each concave portion 80a is appropriately set so that each concave portion 80a acts as the sucker. In addition, in this example, an example in which the sizes of the plurality of concave portions 80a are the same is shown. However, the present disclosure is not limited to this, and different concave portions 80a having a plurality of sizes may be formed on the pressing surface 81.

In this example, when the pressing member 80 is caused to come into contact with the upper wafer (during load application), the upper wafer is adsorbed onto the pressing member 80 by the sucker action of the plurality of concave portions 80a provided in the pressing surface 81.

In addition, in this example, the configuration of the plurality of concave portions 80a (for example, the size of each concave portion 80a, the number of concave portions 80a, and the like) is appropriately set so that the adsorption force generated between the pressing member 80 and the upper wafer is equal to or higher than the displacement force generated between the wafers during temporary bonding. Accordingly, even in this example, the same effect as that of the embodiment is obtained.

### (2) Modified Example 6-2

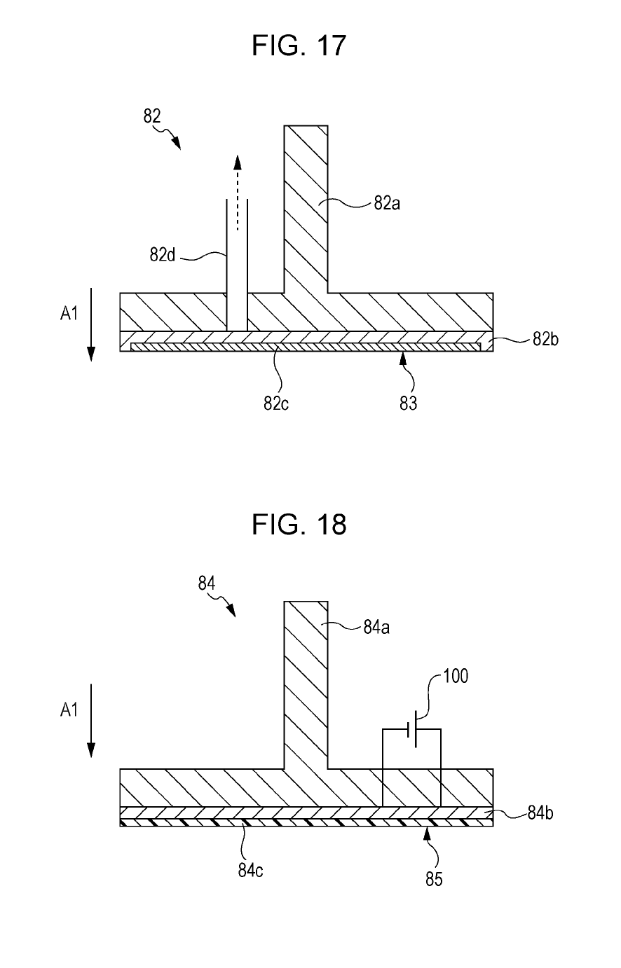

In Modified Example 6-2, the configuration example of the pressing member that adsorbs the upper wafer by vacuum suction will be described. FIG. 17 shows the schematic configuration of the pressing member of Modified Example 6-2. In addition, FIG. 17 is a schematic cross-sectional view of the pressing member in the direction along the pressing direction (the direction of the arrow A1 in FIG. 17).

The pressing member 82 of this example is configured of a pressing member main body 82a, a suction portion 82b, a pressing portion 82c, and a suction pipe 82d.

The pressing member main body 82a may be formed of a material having a sufficient rigidity such as a resin or a hard metal, like the pressing member 3 (FIG. 2) of the embodiment.

The suction portion 82b is a mesh type layer-like (plate-like) member, and is provided on the surface of the pressing member main body 82a on a pressing surface 83 side. The suction portion 82b is produced by forming a hole in a layer made of a material such as a ceramic.

The pressing portion 82c is provided on the surface of the suction portion 82b on the pressing surface 83 side. The pressing portion 82c is formed of a material having a sufficient rigidity such as a metal, a resin, or a ceramic in order to ensure (and maintain) parallelism of the pressing surface 83. In addition, in this example, the suction portion 82b and the pressing portion 82c are configured so as to expose a part of the suction portion 82b on a part on the pressing surface 83.

The suction pipe 82d is mounted on the pressing member main body 82a so that one end portion thereof reaches the surface of the suction portion 82b on the pressing member main body 82a side. In addition, the other end portion of the suction pipe 82d is connected to an external suction apparatus (not shown).

In this example, when the pressing member 82 is caused to come into contact with the upper wafer, the upper wafer is subjected to vacuum suction via the suction pipe 82d and the suction portion 82b, such that the upper wafer is adsorbed onto the pressing member 82.

In addition, in this example, the suction force of vacuum suction is appropriately adjusted so that the adsorption force generated between the pressing member 82 and the upper wafer is equal to or higher than the displacement force generated between the wafers during temporary bonding. Accordingly, even in this example, the same effect as that of the embodiment is obtained.

### (3) Modified Example 6-3

In Modified Example 6-3, a configuration example of the pressing member in which the upper wafer is adsorbed onto the pressing member by an electrostatic chuck method will be described. FIG. 18 shows the schematic configuration of the pressing member of Modified Example 6-3. In addition, FIG. 18 is the schematic cross-sectional view of the pressing member in the direction along the pressing direction (the direction of the arrow A1 of FIG. 18).

A pressing member 84 in this example is configured of a pressing member main body 84a, an electrode portion 84b, and a pressing portion 84c.

The pressing member main body 84a may be formed of a material having a sufficient rigidity such as a resin or a hard metal, like the pressing member 3 (FIG. 2) of the embodiment.

The electrode portion 84b is a layer-like (plate-like) metallic member, and is provided on the surface of the pressing member main body 84a on the pressing surface 85 side. In addition, the electrode portion 84b is electrically connected to an external power supply 100.

The pressing portion 84c is provided on the electrode portion 84b on the pressing surface 85 side. In order to ensure (and maintain) the parallelism of the pressing surface 85 and to ensure insulation between the pressing portion 84c and the upper wafer, the pressing portion 84c is formed of an insulating material having a sufficient rigidity such as a ceramic.

In this example, the pressing member 84 is caused to come into contact with the upper wafer in a state where a voltage is applied to the electrode portion 84b. Otherwise, after the pressing member 84 is caused to come into contact with the upper wafer, a voltage is applied to the electrode portion 84b. Here, by an electrostatic force that is exerted between the pressing member 84 and the upper wafer via the pressing portion 84c, the upper wafer is adsorbed onto the pressing member 84.

In addition, in this example, for example, the voltage applied to the electrode portion 84b or the like is appropriately adjusted so that the adsorption force generated between the pressing member 84 and the upper wafer is equal to or higher than the displacement force generated between the wafers during temporary bonding. Accordingly, even in this example, the same effect as that of the embodiment is obtained.

In addition, the configuration of the pressing member of Modified Example 6 is not limited to the various configuration examples described above, and for example, at least one of the configurations of Modified Examples 1 to 5 may be appropriately combined with any of the configurations of Modified Examples 6-1 to 6-3. In this case, the effect of suppressing the displacement of the upper wafer during temporary bonding can be further enhanced.

### Other Various Modified Examples

In the embodiment and various modified examples, the example in which the bonding surface (adhering surface) of each wafer is activated by a process such as a hydrophilic process and two wafers are directly bonded to each other is described. However, the present disclosure is not limited to this. For example, even in a case where two wafers are bonded to each other via an adhesive or the like, the wafer bonding method and the bonding apparatus described in the embodiment and the various modified examples can be applied similarly, and the same effect is obtained.

In the wafer bonding method and the bonding apparatus of the embodiment and the various modified examples, the example in which a load is applied to the vicinity of the center of the upper wafer by the pressing member is described. However, the present disclosure is not limited to this, and a load application position can be appropriately changed according to, for example, the purpose. For example, a configuration in which a load is applied to the vicinity of the outer peripheral end portion of the upper wafer by the pressing member may also be employed. However, in terms of void suppression, like the embodiment and the various modified examples, it is preferable that a load application position be set to the vicinity of the center of the upper wafer.

In the embodiment and the various modified examples, the method of vertically displacing two wafers to be bonded to each other and the bonding apparatus are described. However, the present disclosure is not limited to this. For example, even in a case where two wafers are horizontally placed on the left and right to be bonded to each other, the wafer bonding method and bonding apparatus described in the embodiment and the various modified examples can be applied similarly, and the same effect is obtained.

In the embodiment and the various modified examples, the example in which two wafers at a wafer level at which, for example, predetermined elements or wires are formed on Si substrates are bonded to each other is described. However, the present disclosure is not limited to this. For example, even in a case where two wafers in which, for example, predetermined elements or wires are not formed on substrates are bonded to each other, the wafer bonding method and the bonding apparatus described in the embodiment and the various modified examples can be similarly applied, and the same effect is obtained.

In addition, the present disclosure may employ configurations as follows.

(1) A substrate bonding method including: causing a pressing member to come into surface contact with a predetermined region of a first substrate and applying a predetermined load to the first substrate; and simultaneously with the applying of the predetermined load or after applying the predetermined load to the first substrate, in the state where the pressing member comes into surface contact with the first substrate, causing the first substrate to come into contact with a second substrate.

(2) The substrate bonding method described in (1), wherein the pressing member is caused to come into surface contact with the first substrate so that a second force that cancels out a first force which is apt to move the first substrate relative to the second substrate, the first force being generated when the first substrate is caused to come into contact with the second substrate, is generated between the pressing member and the first substrate.

(3) The substrate bonding method described in (2) wherein the second force generated between the pressing member and the first substrate is a frictional force, and an area of a contact surface between the pressing member and the first substrate is set so that the frictional force is equal to or higher than the first force.

(4) The substrate bonding method described in (3), wherein a plurality of pressing members are caused to come into surface contact with the first substrate, and the total value of a plurality of contact surfaces is set so that the frictional force generated between the pressing member and the first substrate is equal to or higher than the first force.

(5) The substrate bonding method described in (3) or (4), wherein, when the pressing member is caused to come into contact with the first substrate, a pressing surface of the pressing member rotates so as to be parallel with a pressed surface of the first substrate.

(6) The substrate bonding method described in any one of (2) to (5), wherein the second force generated between the pressing member and the first substrate is an adsorption force.

(7) The substrate bonding method described in any one of (1) to (6), further including performing alignment between the first substrate and the second substrate before causing the pressing member to come into contact with the first substrate.

(8) A substrate bonding apparatus including: a pressing member which comes into surface contact with a predetermined region of a first substrate and applies a predetermined load to the first substrate; and a substrate driving unit which causes the first substrate to come into contact with a second substrate simultaneously with the application of the predetermined load or after the application of the predetermined load to the first substrate by the pressing member.

The present disclosure contains subject matter related to that disclosed in Japanese Priority Patent Application JP 2011-020394 filed in the Japan Patent Office on Feb. 2, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A substrate bonding method comprising:
causing a pressing member to come into surface contact with a predetermined region of a first substrate and applying a predetermined load to the first substrate; and
simultaneously with the applying of the predetermined load or after applying the predetermined load to the first substrate, in the state where the pressing member comes into surface contact with the first substrate, causing the first substrate to come into contact with a second substrate.

2. The substrate bonding method according to claim 1, wherein the pressing member is caused to come into surface contact with the first substrate so that a second force that cancels out a first force which is apt to move the first substrate relative to the second substrate, the first force being generated when the first substrate is caused to come into contact with the second substrate, is generated between the pressing member and the first substrate.

3. The substrate bonding method according to claim 2,
wherein the second force generated between the pressing member and the first substrate is a frictional force, and
an area of a contact surface between the pressing member and the first substrate is set so that the frictional force is equal to or higher than the first force.

4. The substrate bonding method according to claim 3, wherein, when the pressing member is caused to come into contact with the first substrate, a pressing surface of the pressing member rotates so as to be parallel with a pressed surface of the first substrate.

5. The substrate bonding method according to claim 3,
wherein a plurality of pressing members are caused to come into surface contact with the first substrate, and
a total value of a plurality of contact surfaces is set so that the frictional force generated between the pressing member and the first substrate is equal to or higher than the first force.

6. The substrate bonding method according to claim 2, wherein the second force generated between the pressing member and the first substrate is an adsorption force.

7. The substrate bonding method according to claim 1, further comprising performing alignment between the first substrate and the second substrate before causing the pressing member to come into contact with the first substrate.

8. A substrate bonding apparatus comprising:
a pressing member which comes into surface contact with a predetermined region of a first substrate and applies a predetermined load to the first substrate; and
a substrate driving unit which causes the first substrate to come into contact with a second substrate simultaneously with the application of the predetermined load or after the application of the predetermined load to the first substrate by the pressing member.
